(19) United States
(12) Patent Application Publication
(10) Pub. No.: US 2005/0015296 A1
(43) Pub. Date: Jan. 20, 2005

(54) Method for segmenting investors

(76) Inventor: Darryl Dougan, New York, NY (US)

Correspondence Address: Clifford Chance US LLP, 31 West 52nd Street, New York, NY, 10019-6131, US

(21) Appl. No.: 10/856,513

(22) Filed: May 28, 2004

Related U.S. Application Data
(60) Provisional application No. 60/474,866, filed on May 30, 2003.

(51) Int. Cl. G06F 17/60

(52) U.S. Cl. 705/10

(57) ABSTRACT

A method is provided for determining the investing style of a particular investor so to improve the communications between a financial advisor and the investor, and to optimize the provisioning of financial products and services to the investor, and includes the steps of a) determining a plurality of investing styles; b) identifying an optimized question set; c) receiving from the investor, answers to the optimized question set; d) identifying the investor as having one of the plurality of investing styles based on the answers; and e) selectively communicating with the investor based on the identified investing style.

### CROSS-REFERENCE TO RELATED APPLICATION

This application claims the benefit of the filing date of U.S. Provisional Patent Application Ser. No. 60/474,866 entitled “Method For Segmenting Investors,” which was filed on May 30, 2003.

### FIELD

The present invention relates to systems and methods for interacting with investors for the purposes of providing financial services.

### BACKGROUND

The following invention relates to a method and system for determining investing styles and, in particular, to a method and system for determining which of a plurality of investing styles is appropriate for a particular investor so that the provisioning of financial services to the investor may be optimized.

There are a vast and growing number of financial products, strategies, and services available to help investors pursue their financial goals. Investors have to decide whether to invest in equities, interest-bearing instruments, commodities, derivative instruments, or other types of investment vehicles, and also have to design an overall strategy for allocating investment capital and timing any such investment. Most importantly, an effective investment plan includes only those products and services that are suitable and appropriate for the particular investor based on the investor's investment goals, tolerance for risk, and available capital.

Financial institutions that sell financial products and services to investors typically employ financial advisors to help design an appropriate investment plan. This requires that the financial advisor gain an understanding of the investor's investment goals and preferences as well as have knowledge of a broad array of financial products and services that can be used to meet those investment goals. Unfortunately, however, financial advisers often are not fully aware of a particular investor's preferences and goals either because of a failure to ask the investor the right questions regarding the investor's goals and preferences or because of the investor's inability to clearly articulate those goals and preferences. Also, a particular financial advisor may not be familiar with all of the financial products and services that are, or become available, and therefore will not be able to recommend certain products and/or services that would be appropriate for a particular investor.

Prior art methods exist that attempt to automate the process of selecting financial products based on a particular investor's financial goals. For example, Patent Application No. US 2002/0143680 A1 entitled “Financial Planning Method and Computer System,” published Oct. 3, 2002 (hereinafter “Walters”) discloses a system that asks investors questions regarding their personal information, financial history, and financial goals (e.g., investment, income and retirement goals). The system also receives information pertaining to a plurality of financial products and applies a set of rules to the answers provided by the investor to determine the appropriate financial product for the investor.

Another example, U.S. Pat. No. 5,819,263 entitled “Financial Planning System Incorporating Relationship and Group Management,” issued Oct. 6, 1998 (hereinafter “Bromley”) discloses a financial advisor work management tool that receives up to 250 fields of information pertaining to client portfolio information, transaction history, demographic information, and financial information that the financial advisor can organize and use to provide financial planning services.

Yet another example is Patent Application No. US 2002/0147672 A1 entitled “Data-Processing Method and System for Establishing a Personalized Ranking of Financial Investment Products for an Investor,” published Oct. 10, 2002 (hereinafter “Gaini”). In Gaini, an investor responds to a series of questionnaires that include lifestyle questions, personal information questions, and questions relating to investment experience. Based on the investor's answers and an investor “experience corrector,” a portion of the investor's total investable assets are invested into various categories of mutual funds according to a selected predetermined distribution.

The prior art approaches for identifying financial products for a given investor generally have several shortcomings. First, these approaches typically require the investor to provide a significant amount of information including personal information, demographic information, financial goals, and past investment history. Investors, however, are often either reluctant or too busy to respond accurately to extensive questionnaires.

More importantly, the prior art techniques rely significantly on an investor's previous behaviors (e.g., existing investments) in selecting future financial products for the investor. This behavior-oriented approach often results in the selection of financial products for the investor that further perpetuates existing behaviors that may not have been, or is not now, appropriate for the investor. Furthermore, the prior art techniques are solely product-oriented in that they apply rules to the information provided by the investor to merely select a particular financial product for the investor. The prior art techniques do not, however, identify the investor according to a particular investing style so that the financial advisor can better understand the investor's expectations and needs in order to effectively communicate with the investor and better meet the investor's objectives.

Accordingly, it is desirable to provide a method for determining the investing style of a particular investor so to improve the communications between a financial advisor and the investor, and to optimize the provisioning of financial services to the investor.

### SUMMARY OF THE INVENTION

The present invention is directed to overcoming the drawbacks of the prior art. Accordingly, the invention provides a method for determining the investing style of a particular investor so to improve the communications between a financial advisor and the investor, and to optimize the provisioning of financial products and services to the investor.

Specifically, the present invention provides a method for interacting with an investor including the steps of (a) determining a plurality of investing styles; (b) identifying an optimized question set; (c) receiving from the investor answers to the optimized question set; (d) identifying the investor as having one of the plurality of investing styles based on the answers; and (e) selectively communicating with the investor based on the identified investing style. Steps (c) and (d) can be repeated periodically, by way of non-limiting example, every two years.

In some exemplary embodiments, the step of determining a plurality of investing styles includes the steps of presenting to a plurality of investors a questionnaire, collecting survey data from the plurality of investors based on the questionnaire, and partitioning the plurality of investors into a plurality of segments based on the survey data, wherein each of the plurality of segments correspond to one of the plurality of investing styles. In other exemplary embodiments, the step of partitioning includes the step of applying a clustering algorithm to the survey data. The plurality of investing styles can be, by way of non-limiting example, in the range of two to fifteen, or six.

In further exemplary embodiments, the questionnaire includes attitudinal questions, and the step of identifying an optimized question set includes the steps of selecting the attitudinal questions from the questionnaire and selecting a subset of the attitudinal questions based on a predictive model, wherein the subset of attitudinal questions is the optimized question set. The subset can have a size which is based on a desired accuracy associated with the predictive model. The optimized question set can include, by way of non-limiting example, up to 35 questions, or ten questions.

In yet other exemplary embodiments, the step of selectively communicating with the investor includes the step of introducing the investor to financial products, services, and/or tools based on the investor's investing style.

The present invention comprises the features of construction, combination of elements, and arrangement of parts that are exemplified in the following detailed disclosure, and the claims indicate the scope of the invention. Other features and advantages of the invention are apparent from the description, the drawings and the claims.

### DESCRIPTION OF THE DRAWINGS

For a fuller understanding of the invention, reference is made to the following description taken in conjunction with the accompanying drawings, of which:

FIG. 1 is a flowchart of the method for determining an appropriate investing style for a particular investor, in accordance with the present invention;

FIG. 2 is an exemplary implementation of some embodiments of the present invention in a computerized spreadsheet program;

FIG. 3 is a block diagram of a calculating system of the present invention according to some exemplary embodiments; and

FIG. 4 is a block diagram of a calculating system of the present invention according to some exemplary embodiments.

### DETAILED DESCRIPTION OF EMBODIMENTS

As discussed above, the present invention provides systems and methods for determining the investing style of a particular investor so to improve the communications between a financial advisor and the investor, and to optimize the provisioning of financial products and services to the investor. The attached figures provide flowcharts, implementations, and diagrams relating to the systems and methods of the present invention.

Definitions

In order to clearly describe the present invention, the following definitions are utilized in the following description.

A “cluster analysis” can be a procedure which measures Euclidean distances computed from one or more quantitative variables to determine inclusion into one of two or more groups.

An “optimized question set” can be a subset of another question set, which, when administered to respondents, can yield a segmentation of answers that is sufficiently similar to the segmentation attained when administering the other question set to the same respondents. “Attitudinal questions” can be questions that provide a more accurate description of an investor's financial interests and concerns, and can relate, without limitation, to a comfort level in making investment decisions (i.e., risk tolerance), knowledge of financial products, and level of involvement with investments.

A “stepwise discriminant analysis” can be a procedure which calculates the significance level of an F-test from an analysis of covariance in order to determine which variable(s) of a group of two or more variables provide(s) the most information from which to accurately classify a respondent to a question.

A “discriminant analysis” can include stepwise discriminant analysis.

Method Embodiments

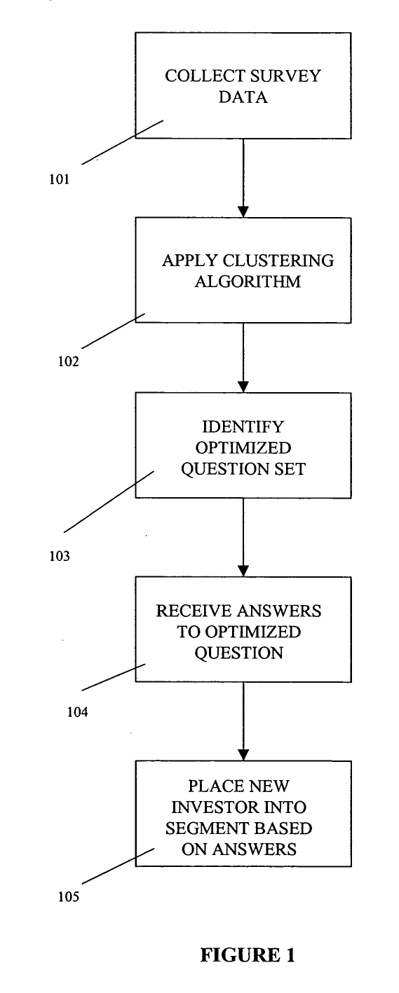

FIG. 1 portrays a flowchart of the method for determining an appropriate investing style for a particular investor, according to the present invention. Initially, in Step 101, survey data, which relates to investment preferences and attitudes of a selected group of investors, can be collected. The survey data can be collected via a questionnaire which can include questions pertaining to investor demographics (e.g., age, income level, marital status), behavior (e.g., past investment activities), and investment attitudes (e.g., risk tolerance, financial knowledge, level of involvement with investments). The questionnaire can include, by way of non-limiting example, up to 200 questions. A non-limiting exemplary questionnaire, intended to illustrate some embodiments of the present invention, follows this Detailed Description of Embodiments, as Appendix A. The questionnaire can be provided to, by way of non-limiting example, 2000-5000 randomly selected individuals. The questionnaire can also be presented, by way of non-limiting example, to 2500 individuals via a telephone survey. In other embodiments, for example, the questionnaire can be provided to individuals over a network, such as, by way of non-limiting example, the Internet, and individuals can provide responses to the questionnaire via a graphical user interface. In yet further embodiments, for example, the questionnaire can be provided to individuals via an in-person interview. The completed questionnaires represent the collected survey data.

Next, in Step 102, a clustering algorithm can be applied to the survey data to partition the survey respondents into a plurality of segments based on their questionnaire answers. Any suitable clustering algorithm can be used to perform this segmentation including, by way of non-limiting example, k-means clustering, weighted clustering, bipolar clustering algorithms, principal component analysis, factor analysis, hierarchical clustering, disjoint clustering, oblique multiple-group component analysis, and correspondence analysis. The number of segments partitioned using the survey data can be, by way of non-limiting example, in the range of 2-15 segments. However, it is preferable that the number of partitioned segments be six, and that each of the segments be of similar size with a maximum variance from the largest segment to the smallest segment in the range of 5-10%.

In some embodiments, such as, for example, those portrayed in Table 1 below, six segments can be partitioned based on the collected survey data whereby each segment represents a percentage of the total number of respondents in the original survey. Further, each segment may be described based on the characteristics of respondents grouped in the particular segment. For example, each of the segments can be profiled using the responses to the demographic, behavioral, and attitudinal questions contained in the questionnaire. Based on the answers to the questionnaire, it may be determined that a “Savvy Skeptic” segment typically consists of young investors, each having a portfolio of a particular size, and each typically making his/her own investment decisions. Table 1 lists the six segments which can be partitioned based on, by way of non-limiting example, the questionnaire of Appendix A, and includes the characteristics of each segment, a descriptive name for each segment based on the segment characteristics, and the percentage that each segment represents of the total number of respondents to the questionnaire.

TABLE 1

| Segment | Segment | | Segment |
|---|---|---|---|
| Number | Description | Segment Characteristics | Percentage |
| 1 | Planners and | Takes active interest in markets, | 12% |
| | Seekers | views financial adviser as having a | |
| | | significant role, average age of 44, | |
| | | average asset base of $310k | |
| 2 | Delegators | Depends heavily on financial | 19% |
| | | advisors to anage portfolio, | |
| | | average age of 54, average | |
| | | asset base of $296k | |
| 3 | Preservers | conservative investors close to | 19% |
| | | retirement that look to financial | |
| | | advisor to help plan for a secure | |
| | | future, average age of 52, average | |
| | | asset base of $175k | |
| 4 | Market | Well educated, self-directed | 15% |
| | Players | investors that occasionally uses a | |
| | | financial advisor as a source of | |
| | | investment information, average | |
| | | age of 49, average asset base | |
| | | of $390k | |
| 5 | Savvy | Self-directed investors, primary | 18% |
| | Skeptics | investment focus is to retire | |
| | | comfortably, uses broker to | |
| | | execute trades but not for | |
| | | investment advice, average age of | |
| | | 49, average asset base | |
| | | of $265k | |
| 6 | Discoverers | Conservative and deliberate | 17% |
| | | investors, intimidated by markets, | |
| | | looks for financial advisors who | |
| | | assist in their investment | |
| | | education, average age of 49, | |
| | | average asset base of $163 | |

Next, in Step 103, the questionnaire can be used to formulate an optimized set of question which will be used with new investors in order to place them into one of the identified segments. In some exemplary embodiments, the optimized question set can be formulated by first selecting only the attitudinal questions contained in the questionnaire. By way of non-limiting example, attitudinal questions can relate to the investor's comfort level in making investment decisions and knowledge of financial products. Attitudinal questions can be useful for formulating the optimized question set because answers to this type of questions can provide a more accurate description of an investor's financial interests and concerns. Behavioral questions, such as, questions relating to the number of transactions made by an investor in the last year, are not useful because answers to such questions often result in perpetuating the investor's past investment behaviors, which may be detrimental when such past behaviors are not suitable under present conditions.

Once the attitudinal questions are selected from the questionnaire, a predictive modeling technique can be applied to find a subset of the attitudinal questions such that the answers that were previously given to these questions in the original survey would result in a segmentation that is sufficiently similar to the one achieved using the original survey data. Any suitable predictive modeling technique can be used including, by way of non-limiting example, logistic regression analysis and decision tree analysis; discriminant analysis (using linear, quadratic, or kernel density functions); classification, regression tree, and neural network for statistical modeling; and non-linear regression. In some exemplary embodiments, discriminant analysis and Bayes' theorem can be used to compute the probability that a respondent's answer to an attitudinal question will come within a segment in Table 1. Several combinations of questions and answers can be analyzed until determining the optimum subset.

The formula for the discriminant model can be:

$$p ( t \vert x ) = \frac{exp ( - 0.5 {D}_{t}^{2} ( x ) )}{{\sum }_{u} exp ( - 0.5 {D}_{u}^{2} ( x ) )} ;$$

where:
p(t|x) can be the posterior probability of a respondent x belonging to group t,
   Dₜ²(x)=dₜ²(x)+g₁(t)+g₂(t),
   dₜ²(x)=(x−mₜ)′Sₚ⁻¹(x−mₜ),
   g₁(t)=0, and
   g₂(t)=−2 ln (qₜ);
   and:
x can be a vector containing a respondent's quantitative answers (1-10 where “1” means “completely disagree” and “10” means “completely agree”) to questions and/or statements,
Sₚ can be the pooled covariance matrix from the discriminant analysis of the original set of respondents,
t can be a subscript to distinguish the individual 6 segments listed in Table 1 above, mₜ can be a vector containing variable means in group t of the original set of respondents, and
qₜ can be the prior probability of membership in group t of a member of the original set of respondents;
resulting in the fully dissected equation:

$$p ( t \vert x ) = \frac{exp \{ - 0.5 [ {( x - {m}_{t} )}^{′} {S}_{p}^{- 1} ( x - {m}_{t} ) - 2 ln ( {q}_{t} ) ] \}}{{\sum }_{i = 1}^{6} exp \{ - 0.5 [ {( x - {m}_{i} )}^{′} {S}_{p}^{- 1} ( x - {m}_{i} ) - 2 ln ( {q}_{i} ) ] \}} .$$

The size of the optimized question set is inversely proportional to the accuracy of the segmentation results obtained using the optimized question set (when compared to the results obtained using the original questionnaire). For example, while an optimized question set containing 20 questions may result in a 92% accuracy, a question set of 8 questions may result in an accuracy of 65%. Additionally, it is desirable to use an optimized question set having a smaller number of questions because it is more likely that new investors will fully and thoroughly answer a smaller optimized question set. In some exemplary embodiments, the predictive modeling technique can be used to identify an optimized question set containing 10 questions. Table 2 shows such an optimized question set having 10 questions and an accuracy of 71% (as compared to the results obtained using the original questionnaire).

TABLE 2

| | |
|---|---|
| 1. | I gather my own investment information and make investment |
| | decisions on my own. |
| 2. | Investing intimidates me. |
| 3. | I love the excitement of trading and investing. |
| 4. | I feel that I definitely need an advisor to help me with my investing. |
| 5. | I follow the stock market on a regular basis. |
| 6. | Mutual funds are a safer way to invest than individual stocks. |
| 7. | I would like to buy investment products through the Internet. |
| 8. | I do not really have enough money to do business with a full service |
| | brokerage firm. |
| 9. | I would rather have a professional manage my investments so I do |
| | not have to worry about them. |
| 10. | The stock market is too risky for me. |

Answer 1-10 where “1” means “completely disagree” and “10” means “completely agree”

As indicated in Step 104, once the optimized question set is identified, it can be given to new investors and the answers to those questions can be used to identify to which of the plurality of segments the investor best belongs. For example, a new investor could be identified as belonging to one of the segments included in Table 1 based on his/her answers to the optimized question set of Table 2. In some exemplary embodiments of the present invention, the equations described above can be transported into a computerized spreadsheet program such as, by way of non-limiting example, MICROSOFT EXCEL™.

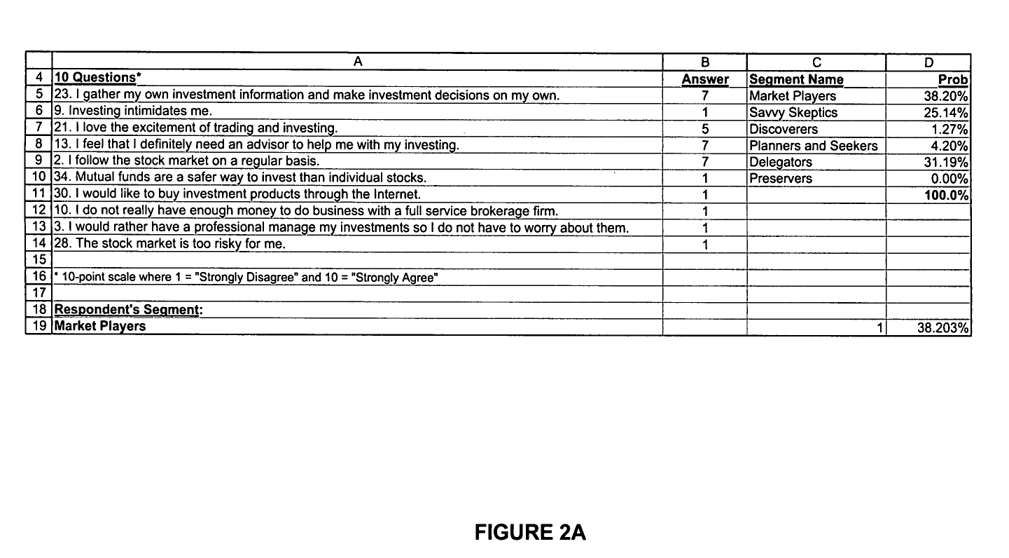

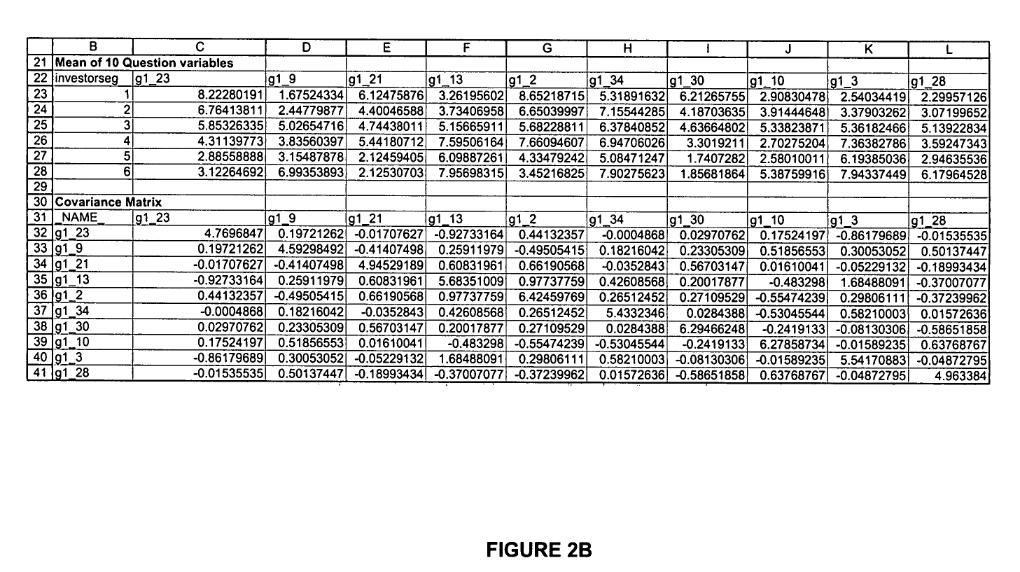

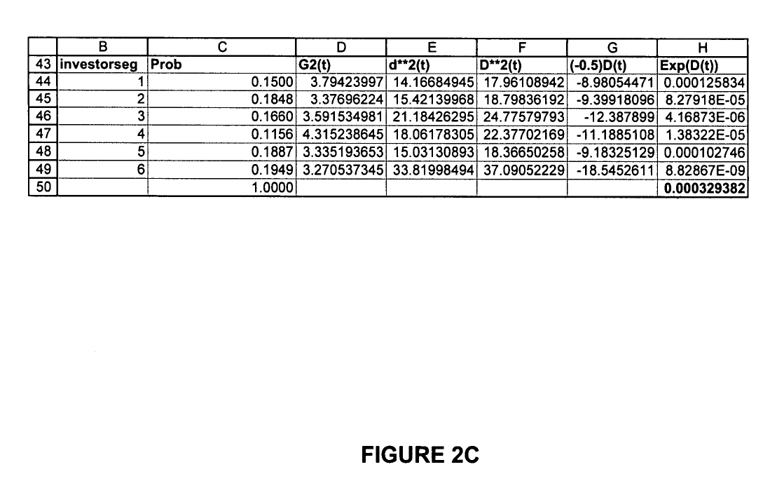

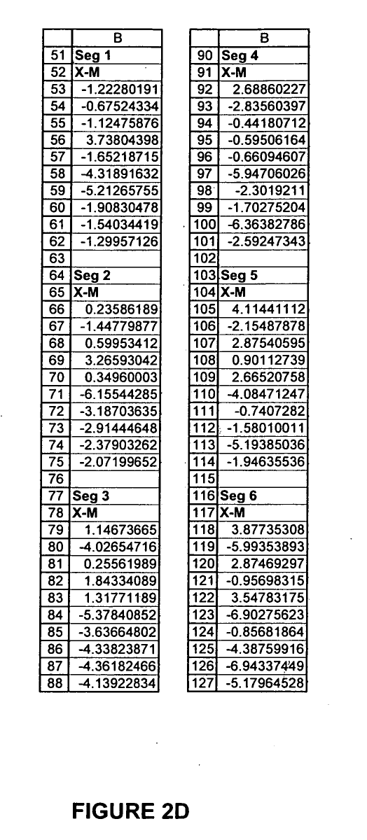

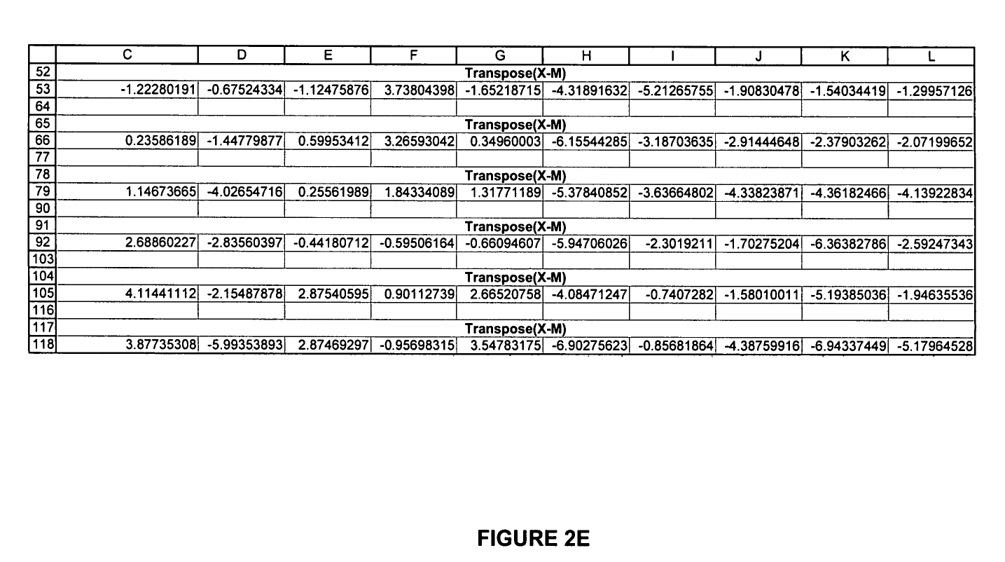

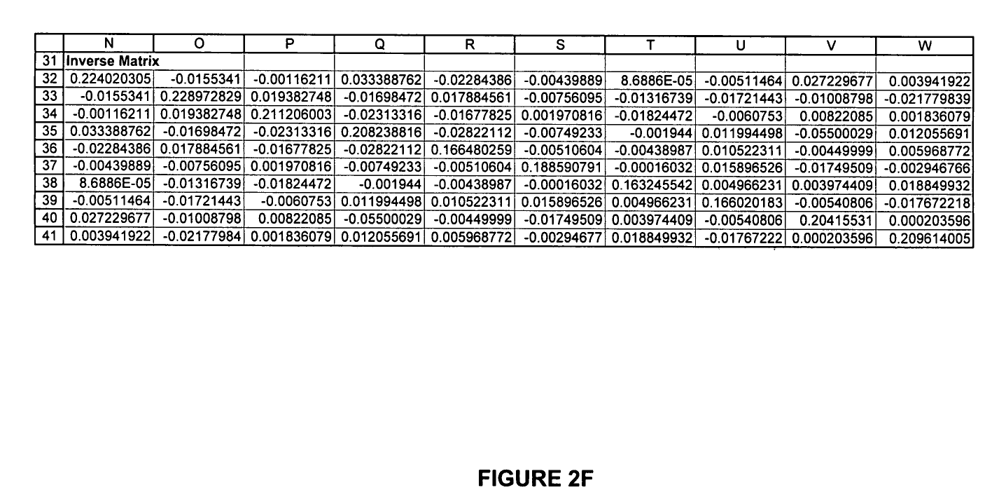

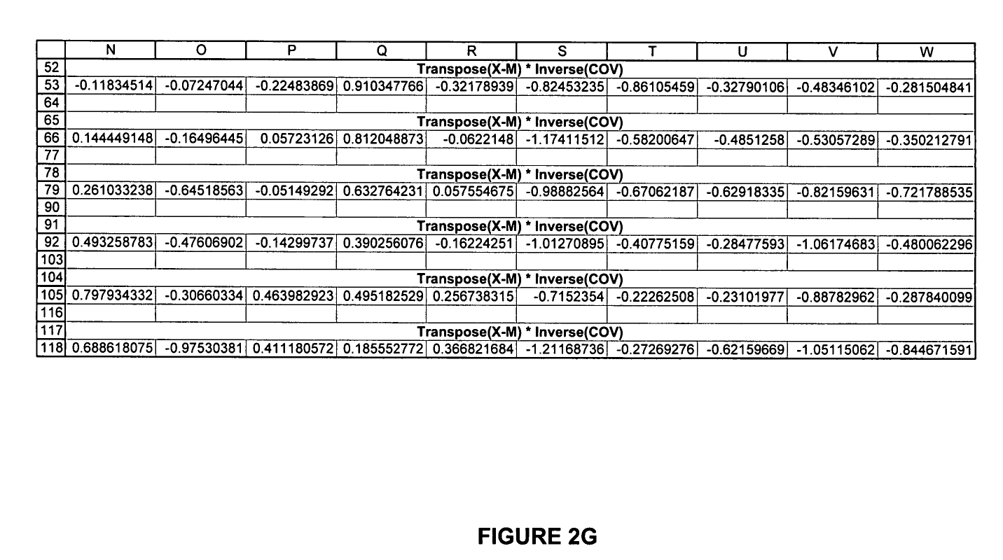

FIG. 2 shows how a computerized spreadsheet program can be used to apply the equations described above to an exemplary answer set to the optimized question set of Table 2, in order to identify a respondent as belonging to, for example, the Market Players segment. What follows are the individual steps for calculating the equations described above, and for determining the segment to which one or more respondents belong. At the end of each of the following steps are the spreadsheet cell(s) of FIG. 2 in which the corresponding calculation is performed, wherein each step can be performed 6 times, once for each segment of Table 1 (with the exception of step 3 which is the inverse of the pooled covariance matrix Sₚ), and wherein:
x can be entered into cells (B5:B14),
Sₚ can be in cells (C32:L41),
mₜ can be in cells (C23:L28), and
qₜ can be in cells (C44:C49).
   1. (x−m₁) can be in cells (B53:B62);
(x−m₂) can be in cells (B66:B75);
(x−m₃) can be in cells (B79:B88);
(x−m₄) can be in cells (B92:B101);
(x−m₅) can be in cells (B105:B114); and
(x−m₆) can be in cells (B118:B127).
   2. (x−m₁)′ can be in cells (C53:L53);
(x−m₂)′ can be in cells (C66:L66);
(x−m₃)′ can be in cells (C79:L79);
(x−m₄)′ can be in cells (C92:L92);
(x−m₅)′ can be in cells (C105:L105); and
(x−m₆)′ can be in cells (C118:L118).
   3. Sₚ⁻¹ can be in cells (N32:W41).
   4. (x−m₁)′Sₚ⁻¹ can be in cells (N53:W53);
(x−m₂)′Sₚ⁻¹ can be in cells (N66:W66);
(x−m₃)′Sₚ⁻¹ can be in cells (N79:W79);
(x−m₂)′Sₚ⁻¹ can be in cells (N92:W92);
(x−m₃)′Sₚ⁻¹ can be in cells (N79:W105); and
(x−m₆)′Sₚ⁻¹ can be in cells (N218:W118).
   5. (x−m₁)′Sₚ⁻¹(x−m₁) can be in cell (E44);
(x−m₂)′Sₚ⁻¹(x−m₂) can be in cell (E45);
(x−m₃)′Sₚ⁻¹(x−m₃) can be in cell (E46);
(x−m₄)′Sₚ⁻¹(x−m₄) can be in cell (E47);
(x−m₅)′Sₚ⁻¹(x−m₅) can be in cell (E48); and
(x−m₆)′Sₚ⁻¹(x−m₆) can be in cell (E49).
   6. −2 ln(q₁) can be in cell (D44);
−2 ln(q₂) can be in cell (D45);
−2 ln(q₃) can be in cell (D46);
−2 ln(q₄) can be in cell (D47);
−2 ln(q₅) can be in cell (D48); and
−2 ln(q₆) can be in cell (D49).
   7. (x−m₁)′Sₚ⁻¹(x−m₁)−2 ln(q₁) can be in cell (F44);
(x−m₂)′Sₚ⁻¹(x−m₂)−2 ln(q₂) can be in cell (F45);
(x−m₃)′Sₚ⁻¹(x−m₃)−2 ln(q₃) can be in cell (P46);
(x−m₄)′Sₚ⁻¹(x−m₄)−2 ln(q₄) can be in cell (P47);
(x−m₁)′Sₚ⁻¹(x−m₅)−2 ln(q₅) can be in cell (P48); and
(x−m₆)′Sₚ⁻¹(x−m₆)−2 ln(q₆) can be in cell (P49).
   8. −0.5[(x−m₁)′Sₚ⁻¹(x−m₁)−2 ln(q₁)] can be in cell (G44);
−0.5[(x−m₂)′Sₚ⁻¹(x−m₂)−2 ln(q₂)] can be in cell (G45);
−0.5[(x−m₃)′Sₚ⁻¹(x−m₃)−2 ln(q₃)] can be in cell (G46);
−0.5[(x−m₄)′Sₚ⁻¹(x−m₄)−2 ln(q₄)] can be in cell (G47);
−0.5[(x−m₅)′Sₚ⁻¹(x−m₄)−2 ln(q₅)] can be in cell (G48); and
−0.5[(x−m₆)′Sₚ⁻¹(x−m₆)−2 ln(q₆)] can be in cell (G49).
   9. exp{−0.5[(x−m₁)′Sₚ⁻¹(x−m₁)−2 ln(q₁)]} can be in cell (H44);
exp{−0.5[(x−m₂)′Sₚ⁻¹(x−m₂)−2 ln(q₂)]} can be in cell (H45);
exp{−0.5[(x−m₃)′Sₚ⁻¹(x−m₃)−2 ln(q₃)]} can be in cell (H46);
exp{−0.5[(x−m₄)′Sₚ⁻¹(−m₄)−2 ln(q₄)]} can be in cell (H47);
exp{−0.5[(x−m₅)′Sₚ⁻¹(x−m₁)−2 ln(q₅)]} can be in cell (H48); and
exp{−0.5[(x−m₆)′Sₚ⁻¹(x−m₆)−2 ln(q₆)]} can be in cell (H49).
10.

$${\sum }_{i = 1}^{6} exp \{ - 0.5 [ {( x - {m}_{i} )}^{′} {S}_{p}^{- 1} ( x - {m}_{i} ) - 2 ln ( {q}_{i} ) ] \} can be in cell ( H 50 ) .$$

11. The probability that the respondent belongs in each segment given their answers to the 10 statements can then be calculated, wherein:
p(1|x) can be in cell (D5);
p(2|x) can be in cell (D6);
p(3|x) can be in cell (D7);
p(4|x) can be in cell (D8);
p(5|x) can be in cell (D9); and
p(6|x) can be in cell (D10).
   12. Finally, “if, then, else” logic in the computerized spreadsheet program can be used to classify a respondent into the one segment with the highest probability, listing the resulting segment in cell (A19).

In Step 105, an investor can be placed into a segment based on his/her answers to the optimized question set. Placing a new investor into one of a number of segments based on the investor's answers to a limited set of “attitudinal” questions enables a financial advisor to service the new investor more effectively. By knowing the segment to which the investor best belongs, the financial advisor can recommend specific services that are likely suitable according to the investor's particular investing styles and preferences (and not merely based on the investor's prior investments). For example, the financial advisor would make investors within the Market Player segment aware of the financial research and trading tools the financial institution has to offer because such investors typically like to make their own investment decisions. By further example, the financial advisor would communicate to investors within the Delegator segment that the financial institution has the research, products, and services to make financial investing as safe and as rewarding as possible because such investors depend on their financial advisor to help make their investing worry-free. Table 3 lists exemplary services a financial advisor may provide to investors belonging to various investor segments. Thus, by placing new investors into segments based on their answers to the optimized question set, the financial advisor can better service the investors according to their particular investment attitudes and preferences.

TABLE 3

| Segment | |
|---|---|
| Description | Segment Characteristics |
| Planners and | Advice on risk, asset allocation, market direction and |
| Seekers | minimization of taxes; clear description of fees paid |
| | and tax information; ability to consolidate portfolio |
| | information across accounts |
| Delegators | Information about specific investments and a guide to |
| | retiring early, advise on risk, financial and retirement |
| | planning, trusts services, estate planning and tax |
| | information |
| Preservers | Reports showing progress made toward financial |
| | goals, advice on retirement planning, net worth |
| | summaries, ideas for minimizing taxes |
| Market Players | Online trading services, analyst research and stock |
| | selection tools, ability to consolidate portfolio, margin |
| | trading, retirement planning information |
| Savvy Skeptics | Software that provides real time market views, |
| | multiple ways to trade (online, phone, etc.), tools to help |
| | select mutual funds based on own criteria |
| Discoverers | Advice on asset management, future goals and retirement |
| | planning, opportunities to learn basics of investing, |
| | ability to trade independent of broker |

The present method of segmenting investors can also be used with existing investors of a financial institution. Such investors can be requested to provide answers to an optimized question set on a periodic basis. For example, investors may update the answers to an optimized question set once every two years, thereby providing their investment attitudes as they evolve over time.

A number of embodiments of the present invention have been described. Nevertheless, it will be understood that various modifications may be made without departing from the spirit and scope of the invention.

System Embodiments

Based on the above description, it would be obvious to one of ordinary skill that some implementations of the present invention can include proprietary software installed from a computer readable medium, such as a CD-ROM. Inventive concepts may therefore be implemented in digital electronic circuitry, computer hardware, firmware, software, or in combinations of the above. Data can be generated, received, transmitted, processed and stored as digital data. In addition, it would be obvious to use a conventional database management system such as, by way of non-limiting example, SYBASE™, ORACLE™ and DB2™, as a platform for implementing the present invention.

Some apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output.

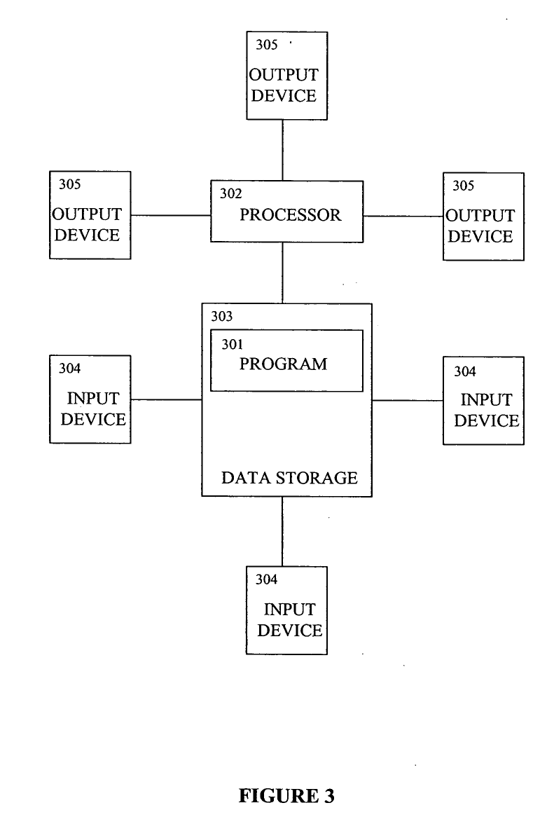

For example, FIG. 3 illustrates an embodiment in which one or more computer programs (301) are executable on a programmable system (300) including at least one programmable processor (302) coupled to receive data and instructions from, and to transmit data and instructions to, a digital data storage system or other electronic storage (303); at least one input device (304); and at least one output device (305).

Each computer program may be implemented in a high-level procedural or object-oriented programming language, or in assembly or machine language if desired; and in any case, the language may be a compiled or interpreted language. Suitable processors include, by way of example, both general and special purpose microprocessors.

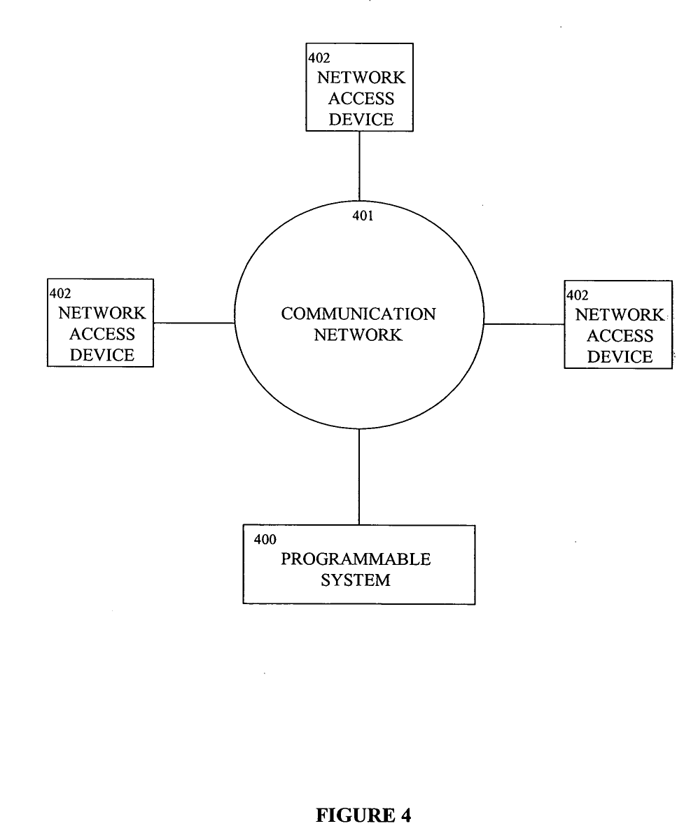

Also, as shown in FIG. 4, the programmable system of FIG. 3 (300) can be implemented over a communication network (401). Network access devices (402) can include personal computers executing operating systems such as MICROSOFT WINDOWS™, UNIX™, or APPLE MAC OS™, as well as software applications, such as JAVA™ programs or web browsers. Other network access devices can be terminal devices, palm-type computers, mobile WEB access devices, or other devices that can adhere to a point-to-point or network communication protocol such as the Internet protocol. Computers and network access devices can include processors, RAM and/or ROM memories, display capabilities, input devices, and hard disk or other relatively permanent storage.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A computer-implemented method for determining an investing style of an investor so to improve communication with a financial advisor and optimize the provisioning of financial products and services to the investor, comprising the steps of:
a) determining in a computer system storage, a plurality of investing styles;
b) identifying in the computer system storage, an optimized question set;
c) receiving into the computer system storage from said investor, answers corresponding to said optimized question set;
d) identifying in the computer system storage, said investor as having one of said plurality of investing styles based on said answers; and
e) selectively communicating with said investor based on said identified investing style.

2. The method of claim 1, wherein the step of determining in a computer system storage, a plurality of investing styles includes the steps of:
presenting to a plurality of investors a questionnaire;
collecting survey data from said plurality of investors based on said questionnaire; and
partitioning in the computer system storage, said plurality of investors into a plurality of segments based on said survey data, wherein each of said plurality of segments corresponds to one of said plurality of investing styles.

3. The method of claim 2, wherein the step of partitioning includes the step of:
applying in the computer system storage, a clustering algorithm to said survey data.

4. The method of claim 1, wherein said plurality of investing styles is in the range of two to fifteen.

5. The method of claim 1, wherein said plurality of investing styles is six.

6. The method of claim 2, further including the step of:
characterizing in the computer system storage, each of said investing styles based on said collected survey data.

7. The method of claim 1, wherein said questionnaire includes attitudinal questions, and wherein the step of identifying in the computer system storage, an optimized question set includes the steps of:
selecting in the computer system storage, said attitudinal questions from said questionnaire; and
selecting in the computer system storage, a subset of said attitudinal questions based on a predictive model, wherein said subset of attitudinal questions is said optimized question set.

8. The method of claim 7, wherein said subset has a size, and the size of said subset is based on a desired accuracy associated with said predictive model.

9. The method of claim 1, wherein said optimized question set includes up to 35 questions.

10. The method of claim 1, wherein said optimized question set includes ten questions.

11. The method of claim 1, wherein the step of selectively communicating with said investor includes the step of:
introducing said investor to at least one of a financial product, a financial service, and a financial tool based on said investor's investing style.

12. The method of claim 1, further comprising the step of:
repeating steps (c) and (d) periodically.

13. The method of claim 12, wherein said period is two years.

14. A computer system for determining an investing style of an investor so to improve communication with a financial advisor and optimize the provisioning of financial products and services to the investor, the system comprising:
a programmable processor;
a computer software executable on the computer system;
a data storage system;
at least one input device; and
at least one output device;
the computer software operative with the processor to:
cause the data storage system to (a) receive data via the at least one input device;
cause the processor to:
(b) determine a plurality of investing styles based on said data; and
(c) identify an optimized question set;
further cause the data storage system to (d) receive from said investor, answers corresponding to said optimized question set, via the at least one input device; and
further cause the processor to:
(e) identify said investor as having one of said plurality of investing styles; and
(f) selectively communicate with said investor based on said identified investing style, via the at least one output device.

15. A computer system for determining an investing style of an investor so to improve communication with a financial advisor and optimize the provisioning of financial products and services to the investor, the system comprising:
a programmable processor;
a computer software executable on the computer system;
a data storage system;
at least one input device; and
at least one output device;
the computer software operative with the processor to:
cause the processor to (a) present to a plurality of investors, a questionnaire, via the at least one output device;
cause the data storage system to (b) receive from said plurality of investors, survey data based on said questionnaire, via the at least one input device;
further cause the processor to:
(c) partition said plurality of investors into a plurality of segments based on said survey data, wherein each of said plurality of segments corresponds to one of said plurality of investing styles; and
(d) identify an optimized question set;
further cause the data storage system to (e) receive from said investor, answers corresponding to said optimized question set, via the at least one input device; and
further cause the processor to:
(f) identify said investor as having one of said plurality of investing styles; and
(g) selectively communicate with said investor based on said identified investing style, via the at least one output device.

16. The system of claim 15, wherein the operability of the computer software with the processor to cause the processor to partition said plurality of investors into a plurality of segments based on said survey data includes operability to cause the processor to:
apply a clustering algorithm to said survey data.

17. The system of claim 14, wherein said plurality of investing styles is in the range of two to fifteen.

18. The system of claim 14, wherein said plurality of investing styles is six.

19. The system of claim 15, wherein the computer software is further operative with the processor to cause the processor to:
characterize each of said investing styles based on said collected survey data.

20. The system of claim 14, wherein said questionnaire includes attitudinal questions, and wherein the operability of the computer software with the processor to cause the processor to identify an optimized question set includes operability to cause the processor to:
select said attitudinal questions from said questionnaire; and
select a subset of said attitudinal questions based on a predictive model, wherein said subset of attitudinal questions is said optimized question set.

21. The system of claim 20, wherein said subset has a size, and the size of said subset is based on a desired accuracy associated with said predictive model.

22. The system of claim 14, wherein said optimized question set includes up to 35 questions.

23. The system of claim 14, wherein said optimized question set includes ten questions.

24. The system of claim 14, wherein the operability of the computer software with the processor to cause the processor to selectively communicate with said investor includes operability to cause the processor to:
provide said investor with a financial product based on said investor's investing style, via the at least one output device.

25. The system of claim 14, wherein the computer software is further operative with the processor to cause the processor to:
repeat steps (d) and (e) periodically.

26. The system of claim 25, wherein said period is two years.
